(19) United States
(12) Patent Application Publication
(10) Pub. No.: US 2026/0228966 A1
(43) Pub. Date: Aug. 6, 2026

(54) THREE-DIMENSIONAL SCENE GRAPH AUTOLABELING

(71) Applicant: NVIDIA Corporation, Santa Clara, CA (US)

(72) Inventors: Han ZHANG, Stanford, CA (US); Subhashree RADHAKRISHNAN, Milipitas, CA (US); Vidya NARIYAMBUT MURALI, Sunnyvale, CA (US); Parthasarathy SRIRAM, Los Altos Hills, CA (US); Xiaolong LI, Santa Clara, CA (US); Yilin ZHAO, Santa Clara, CA (US)

(73) Assignee: NVIDIA Corporation, Santa Clara, CA (US)

(21) Appl. No.: 19/043,162

(22) Filed: Jan. 31, 2025

(51) Int. Cl. G06T 17/00; G06T 13/40; G06V 10/25; G06V 20/70

(52) U.S. Cl. CPC G06T 17/00; G06T 13/40; G06V 10/25; G06V 20/70

(57) ABSTRACT

In various examples, a computing system can generate a first edge representing an action of a subject in a three-dimensional (3D) scene with respect to an object in the 3D scene. The computing system can generate, based at least on the action and one or more bounding boxes of the subject in one or more views of the 3D scene, a caption representing the subject. The computing system can generate, based at least on 3D coordinates for the 3D scene, a second edge representing a spatial relationship between the subject and the object. The computing system can update a 3D graph of the 3D scene to include a first node that corresponds to the subject and comprises the caption and a second node that corresponds to the object, the 3D graph mapping the first edge and the second edge between the first node and the second node.

### BACKGROUND

Machine learning models can be trained to generate descriptions of scenes, such as by being provided labeled data regarding example scenes. For example, model training can involve providing various amounts of text and/or image data to language models. However, the available 3D data is orders of magnitude less than that of text and/or images. As such, it is challenging to train machine learning models to have sufficient performance in handling tasks relating to 3D data, such as extracting information from 3D scenes or performing tasks regarding 3D scenes or other 3D data structures or information.

Additionally, some systems can process 3D-type data regarding scenes but can lack accuracy due to how the data is processed. For example, some approaches rely on point cloud reconstruction from RGB-D images, which is often not accurate and can introduce errors in objects'3D coordinates. Some approaches label nodes (for objects) using class labels, but without additional information, resulting in scarce data for downstream operations. Some approaches are limited to static scenes or to spatial relationships without accounting for actions amongst objects.

### SUMMARY

Implementations of the present disclosure relate to systems and methods for autolabeling graphs, such as generating 3D scene graphs and downstream annotations. Systems and methods are disclosed that can process 3D data structures or information and can generate captions based on the 3D data structures or information.

In contrast to conventional systems, systems and methods in accordance with the present disclosure can process accurate ground-truth 3D information, e.g., from a simulation (e.g., digital twin simulation) of a scene, to generate more accurate 3D scene graphs. The system can generate captions regarding objects (including subjects, e.g., humans or other actors) in the scene to facilitate more rich data generation. The system can determine interactions amongst objects, such as human interactions with objects. The system can generate 3D scene graphs that include nodes for objects and edges for both interaction relationships and spatial relationships in the 3D scene. The system can use information from multiple views of the scene to facilitate more accurate caption generation. The system can provide detailed and/or diverse spatial relationship information, such as from a common frame of reference, e.g., relative to ground. Various such features can allow for more scalable annotation of synthetic 3D scenes and/or generation of data for training language models to handle 3D tasks.

At least one aspect relates to one or more processors including processing circuitry. The processing circuitry can generate a first edge representing an action of a subject in a three-dimensional (3D) scene with respect to an object in the 3D scene. The processing circuitry can generate, based at least on the action and one or more bounding boxes of the subject in one or more views of the 3D scene, a caption representing the subject. The processing circuitry can generate, based at least on 3D coordinates for the 3D scene, a second edge representing a spatial relationship between the subject and the object. The processing circuitry can update a 3D graph of the 3D scene to include a first node that corresponds to the subject and comprises the caption and a second node that corresponds to the object, the 3D graph mapping the first edge and the second edge between the first node and the second node. In some implementations, the processing circuitry is to retrieve, from a simulation of the 3D scene, the action, the one or more bounding boxes, the 3D coordinates, and a class label of at least one of the subject or the object.

In some implementations, the processing circuitry is to generate the caption based at least on a class label of the subject. In some implementations, the processing circuitry is to generate the first edge, the caption, and the second edge using one or more language models.

In some implementations, the object is a first object and the caption is a first caption, and the processing circuitry is to generate, using a language model, a second caption of the first object, a third caption of a second object in the 3D scene, and a third edge between the second object and at least one of the subject or the first object, and to update the 3D graph to assign the second caption to the second node and the third caption to a third node representing the second object.

In some implementations, a plurality of views of the scene comprise the one or more views, and a plurality of bounding boxes of the subject comprise the one or more bounding boxes, and the processing circuitry is to generate, using a language model and for each view of the plurality of views, a view caption of the subject, and to generate the caption based at least on the view caption for each view of the plurality of views.

In some implementations, the processing circuitry is to update a vision language model (VLM) according to the 3D graph. In some implementations, the processing circuitry is to determine the spatial relationship, based at least on the 3D coordinates, relative to a predetermined frame of reference of the scene.

At least one aspect relates to a system that includes one or more processors. The one or more processors can obtain, from a simulation environment, one or more views of a three-dimensional (3D) scene for generating a 3D graph of the 3D scene. The one or more processors can determine a first edge representing an action of a subject on an object in the 3D scene. The one or more processors can determine, based at least on the action and one or more bounding boxes of the subject in the one or more views of the 3D scene, a caption representing the subject. The one or more processors can determine, based at least on 3D coordinates for the 3D scene, a second edge representing a spatial relationship between the subject and the object. The one or more processors can generate the 3D graph of the 3D scene using at least the first edge, the second edge, the caption, a first node corresponding to the subject, and a second node corresponding to the object.

In some implementations, the one or more processors are to retrieve, from a simulation of the 3D scene, the action, the one or more bounding boxes, the 3D coordinates, and a class label of at least one of the subject or the object. In some implementations, the one or more processors are to generate the caption based at least on a class label of the subject. In some implementations, the one or more processors are to generate the first edge, the caption, and the second edge using one or more language models.

In some implementations, the object is a first object and the caption is a first caption, and the one or more processors are to generate, using a language model, a second caption of the first object, a third caption of a second object in the 3D scene, and a third edge between the second object and at least one of the subject or the first object, and to update the 3D graph to assign the second caption to the second node and the third caption to a third node representing the second object. In some implementations, a plurality of views of the scene comprise the one or more views, and a plurality of bounding boxes of the subject comprise the one or more bounding boxes, and the one or more processors are to generate, using a language model and for each view of the plurality of views, a view caption of the subject, and to generate the caption based at least on the view caption for each view of the plurality of views.

In some implementations, the one or more processors are to update a vision language model (VLM) according to the 3D graph. In some implementations, the one or more processors are to determine the spatial relationship, based at least on the 3D coordinates, relative to a predetermined frame of reference of the scene.

At least one aspect relates to a method. The method can include obtaining, from a simulation environment, a dataset comprising at least a plurality of views associated with a three-dimensional (3D) scene. The method can include updating, based at least on the dataset, a 3D graph of the 3D scene by generating a first node representing a subject in the 3D scene and a second node representing an object in the 3D scene, generating a first edge representing an action of the subject with respect to the object, generating, based at least on the action and one or more bounding boxes of the subject in the plurality of views of the 3D scene, a caption representing the subject, and generating, based at least on 3D coordinates for the 3D scene, a second edge representing a spatial relationship between the subject and the object.

The processors, systems, and/or methods described herein can be implemented by or included in at least one a system. The system can include a system for generating synthetic data. The system can include a system implementing one or more large language models (LLMs). The system can include a system implementing one or more small language models (SLMs). The system can include a system implementing one or more vision language models (VLMs). The system can include a system for performing conversational AI operations. The system can include a system implementing one or more multi-model language models. The system can include a perception system for an autonomous or semi-autonomous machine. The system can include a system for performing simulation operations. The system can include a system for performing digital twin operations. The system can include a system for performing light transport simulation. The system can include a system for performing collaborative content creation for 3D assets. The system can include a system for performing deep learning operations. The system can include a system for performing remote operations. The system can include a system for performing real-time streaming. The system can include a system for generating or presenting one or more of augmented reality content, virtual reality content, or mixed reality content. The system can include a system implemented using an edge device. The system can include a system implemented using a robot. The system can include a system for generating synthetic data using AI. The system can include a system incorporating one or more virtual machines (VMs). The system can include a system implemented at least partially in a data center. The system can include a system implemented at least partially using cloud computing resources.

### BRIEF DESCRIPTION OF THE DRAWINGS

The present systems and methods for 3D scene graph autolabeling are described in detail below with reference to the attached drawing figures, wherein:

FIG. 1 is a block diagram of an example of a system, in accordance with some implementations of the present disclosure;

FIG. 2 is a flow diagram of an example of a method for updating a 3D scene graph, in accordance with some implementations of the present disclosure;

FIG. 3 is an example 3D scene graph including any one or more nodes and edges, in accordance with some implementations of the present disclosure;

FIG. 4A is a block diagram of an example generative language model system suitable for use in implementing at least some implementations of the present disclosure;

FIG. 4B is a block diagram of an example generative language model that includes a transformer encoder-decoder suitable for use in implementing at least some implementations of the present disclosure;

FIG. 4C is a block diagram of an example generative language model that includes a decoder-only transformer architecture suitable for use in implementing at least some implementations of the present disclosure;

FIG. 5 is a block diagram of an example computing device suitable for use in implementing at least some implementations of the present disclosure; and

FIG. 6 is a block diagram of an example data center suitable for use in implementing at least some implementations of the present disclosure.

### DETAILED DESCRIPTION

Systems and methods are disclosed related to autolabeling graphs, such as generating 3D scene graphs and downstream annotations, such as supervised-finetuning (SFT) question-answering and task planning annotations. This can be useful, for example, for training vision language models (VLMs) (and/or other language models such as multi-modal language models (MMLMs)) based on 3D data and information.

Some datasets for model training include various amounts of text and/or image data. However, this data may not be useful for configuring (e.g., training, updating, fine-tuning) VLMs as they lack three-dimensional (3D) data. As such, it can be challenging to train machine learning models to have sufficient performance in handling tasks relating to 3D data, such as extracting information from 3D scenes or performing tasks regarding 3D scenes or other 3D data structures or information. Additionally, some traditional systems process 3D-type data regarding scenes; however, such approaches can lack accuracy due to how the data is processed. For example, some approaches can rely on point cloud reconstruction from RGB-D images, which is often not accurate and can introduce errors in objects'3D coordinates. Some approaches can label nodes (for objects) using class labels; however, such approaches can result in scarce data for downstream operations without additional information. Some approaches are limited to static scenes or to spatial relationships without accounting for actions amongst objects.

Systems and methods in accordance with the present disclosure can implement a 3D scene graph generation pipeline that achieves more accurate performance, and that can generate annotations for the 3D scene graphs based on scene data. The system can obviate the need to constrain scene data to static scenes and/or rely on ground-truth information of the scene data.

For example, the system can receive information for generating the 3D scene graph from a simulation (e.g., digital twin simulation), which can thus be ground truth information regarding the 3D scene to allow for more accurate information to be generated for the 3D scene graph.

The system can generate captions regarding objects (including subjects, e.g., humans or other actors) in the scene to facilitate more rich data generation. The system can generate, based at least on ground-truth object information (e.g., class labels, one or more 2D bounding boxes of the objects, one or more 3D bounding boxes of the objects, action labels), a caption representing the objects.

The system can use information from multiple views of the scene to facilitate more accurate, diverse, and/or detailed information for caption generation for the 3D scene graph. For example, the system can use object data (e.g., one or more 2D bounding boxes, class labels) in one or more 2D views of the scene as input to a language model to cause the language model to generate one or more captions for the object. The system can combine (e.g., fuse), using the same or a different language model, the one or more captions to construct a node (e.g., holistic description of the object, fused object caption).

For humans and other actors within the scene, the system can use subject data (e.g., action labels, one or more 2D bounding boxes, class labels) in one or more 2D views of the scene as input to a language model to cause the language model to generate one or more captions for the subject. The system can combine (e.g., fuse), using the same or a different language model, the one or more captions to construct a node (e.g., holistic description of the action performed by the human, fused human caption).

The system can provide 3D scene graphs that include nodes for objects and edges for both interaction relationships and spatial relationships in the 3D scene. For example, the system can predict an interaction edge (e.g., when a human is present in the scene), using a language model, based at least on the action label (e.g., description of the action) and the class labels in the scene.

The system can generate, based at least on 3D coordinates for the scene, edges representing spatial relationships between the one or more objects. The system can provide detailed and/or diverse spatial relationships for objects in the scene, such as from a common frame of reference, e.g., relative to ground. For example, the system can determine a node hierarchy according to how objects are arranged relative to ground, such as by starting with objects that are supported by the ground. The system can determine spatial relationships amongst objects in each level of the hierarchy.

The system can generate a 3D scene graph and highly detailed scene graph annotations and can allow for more scalable annotation of synthetic 3D scenes and/or generation of data for training language models to handle 3D tasks.

In some implementations, the system uses the 3D scene graph to generate data for training downstream models, e.g., vision language model (VLMs). For example, the system can query the 3D scene graph to retrieve annotations regarding the scene to update a VLM.

For example, the system can generate a first edge representing an action of a subject in a 3D scene with respect to an object in the scene. The system can generate, based at least on the action and one or more bounding boxes of the subject in one or more views of the scene, a caption representing the subject. The system can generate, based at least on 3D coordinates for the scene, a second edge representing a spatial relationship between the subject and the object. The system can update a 3D graph of the scene to include a first node that corresponds to the subject and includes the caption and a second node that corresponds to the object, the 3D graph mapping the first edge and the second edge between the first node and the second node. In some implementations, the system uses the 3D scene graph to generate data for training downstream models, e.g., vision language model (VLMs). For example, the system can query the 3D scene graph to retrieve annotations regarding the scene to update a VLM. The system can receive information for generating the 3D scene graph from a simulation, which can thus be ground truth information regarding the 3D scene to allow for more accurate information to be generated for the 3D scene graph. In some implementations, the system uses information from multiple views of the scene to facilitate generating more accurate, diverse, and/or detailed information for the 3D scene graph. For example, the system can use two-dimensional (2D) bounding boxes for an object in one or more 2D views of the scene as input to a language model to cause the language model to generate a caption for the object, and can combine, e.g., using the same or a different language model, the captions to provide a holistic description of the object. The system can generate more structured spatial relationships for objects in the scene. For example, the system can determine a node hierarchy according to how objects are arranged relative to ground, such as by starting with objects that are supported by the ground. The system can determine spatial relationships amongst objects in each level of the hierarchy.

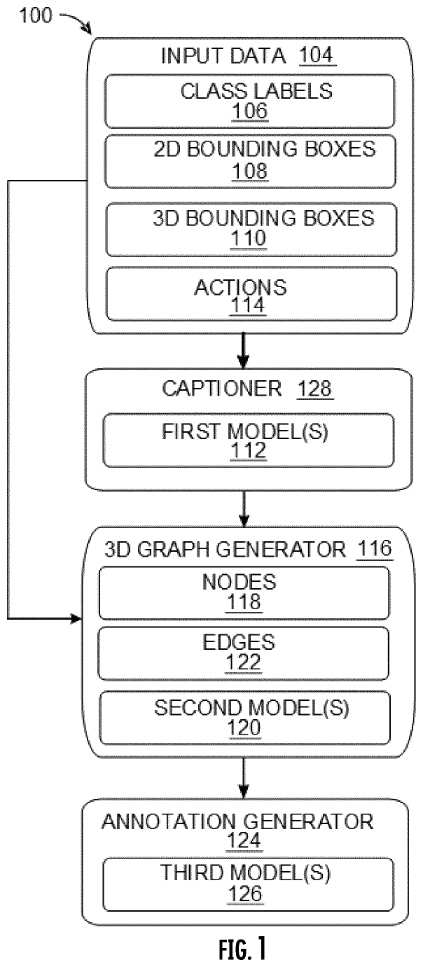

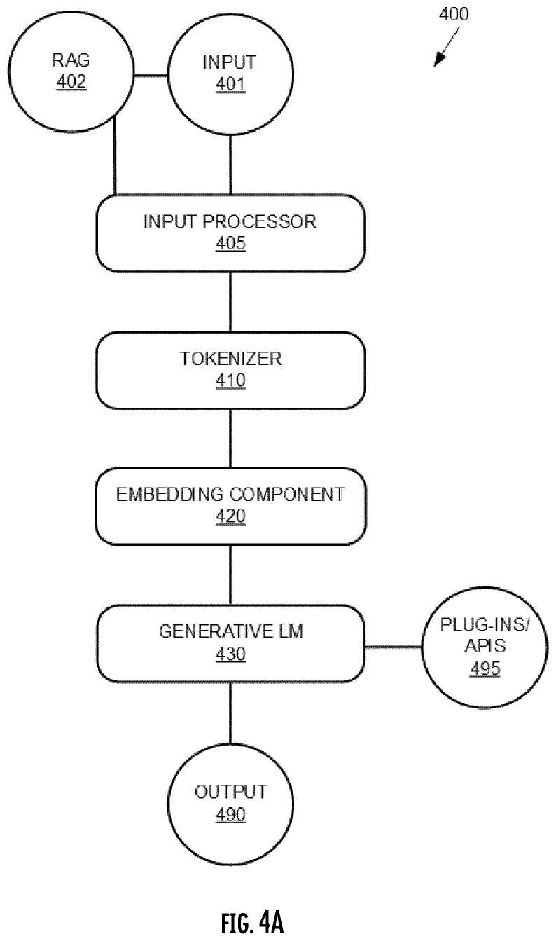

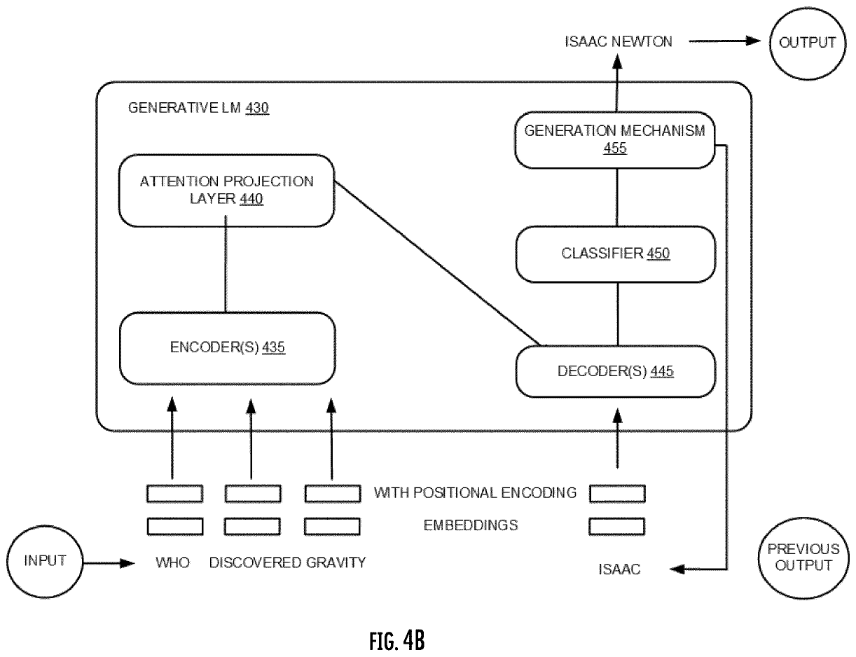

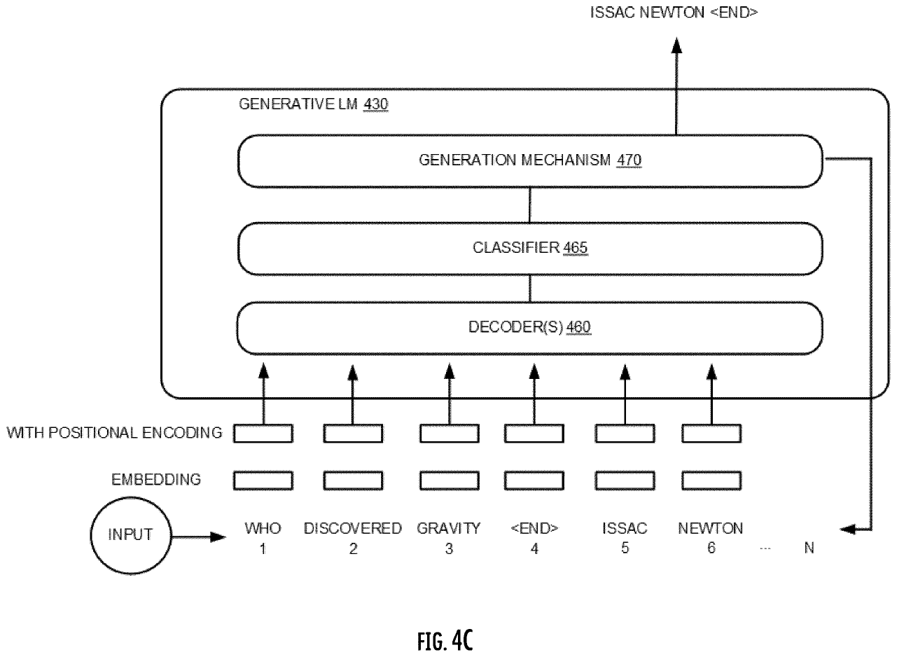

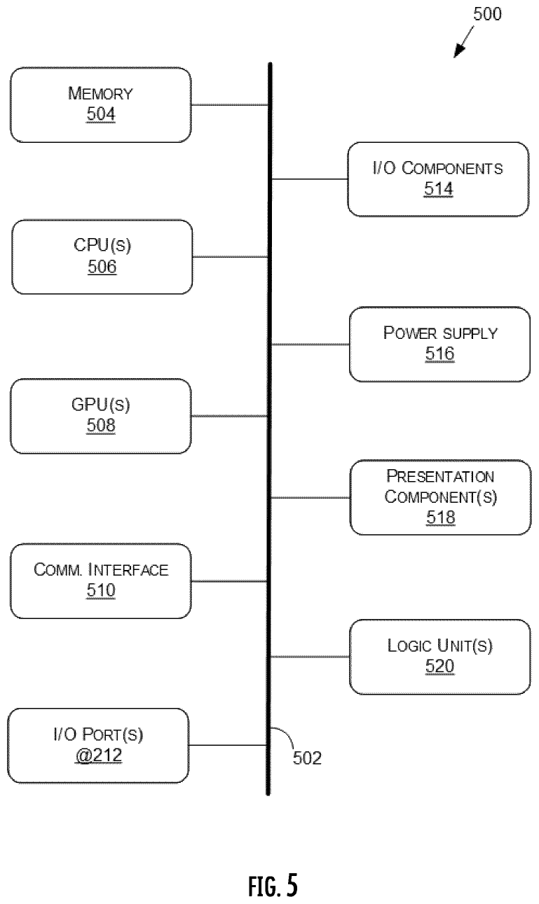

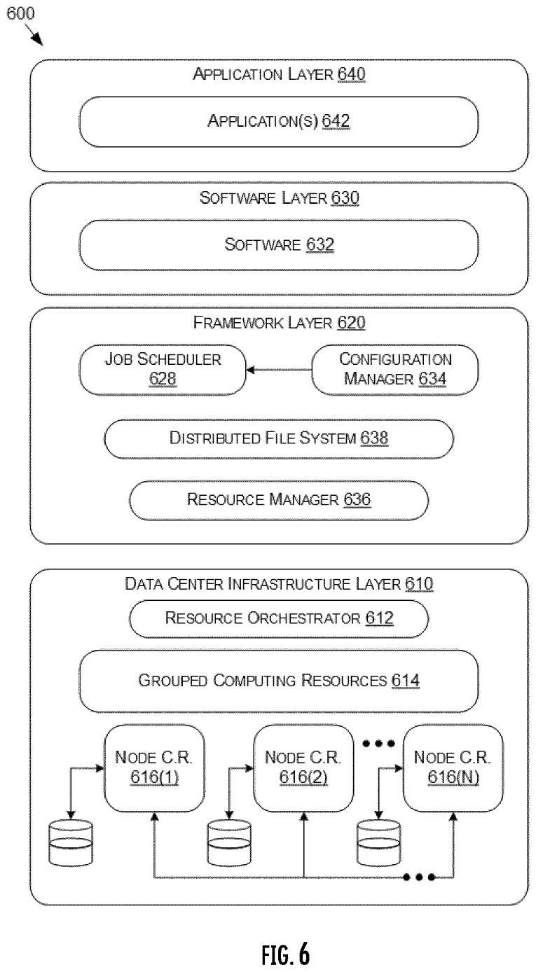

With reference to FIG. 1, FIG. 1 is an example block diagram of system 100, in accordance with some implementations of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some implementations, the system and methods described herein may be implemented using one or more generative language models (e.g., as described in FIGS. 4A-4C), one or more computing devices or components thereof (e.g., as described in FIG. 5), and/or one or more data centers or components thereof (e.g., as described in FIG. 6).

The system 100 can be used to generate a 3D scene graph regarding a scene. The system 100 can be used to generate richer annotations for objects represented in the 3D scene graph, which can be used to allow for improved training/updating of downstream applications or other downstream tasks. In some implementations, the system 100 can include one or more machine learning models (e.g., large language models (LLMs), small language models (SLMs), vision language models (VLMs), multi-modal language models (MMLMs), etc.) to generate a 3D scene graph and annotations for the 3D scene graph, including first model(s) 112, second model(s) 120, and third model(s) 126.

The system 100 can implement at least a portion of a 3D scene graph pipeline such as an annotation generating pipeline, a fused-caption generating pipeline, and/or an end-to-end supervised fine-tuning (SFT) pipeline. The system 100 can be used to generate 3D scene graphs and instruction-following annotations by any of various systems described herein, including but not limited to automotive vehicle systems, medical imaging systems, surveillance systems, interactive display systems, environmental monitoring systems, digital twin systems, augmented reality systems, virtual reality systems, and/or mixed reality systems.

In some implementations, the system 100 can receive input data 104 (e.g. and without limitation, from a digital twin simulation). The system 100 can include or be coupled with one or more data sources such as input data 104. The input data 104 can include or the system 100 can receive the input data 104 from any of various databases, data sets, data repositories, or from a remote device via a network connection, for example. As described further herein, the system 100 can use at least a subset of the input data 104 to be inputted to models, such as inputted to a model 112 (e.g., a first model 112) to generate one or more captions based at least on the input data 104.

The input data 104 can include one or more views (e.g., images) regarding a scene. For example, a plurality of views (e.g., front, behind, left, right, perspective, etc.) can be provided to the system 100 of the same scene, providing additional information regarding the scene to the system 100 which can be beneficial for performing downstream tasks.

The system 100 can receive ground-truth information regarding the one or more views of the scene (e.g., and without limitation, from the digital twin simulation). The system 100 can receive ground-truth information for each object (item, article, device, etc.) and/or subject (human or animal) in the scene. Ground-truth object information can include class labels 106 (which can indicate classes and/or categories of objects in a scene), 2D bounding boxes (e.g., 2D bounding box coordinates) 108, and/or 3D bounding boxes (e.g., 3D bounding box coordinates) 110. The bounding boxes can be assigned information regarding objects or features in the bounding boxes. Ground-truth subject information can include, for each subject present in the scene, a short sentence describing an action that the subject is performing, shown as actions 114, as well as a corresponding class label 106 and 2D bounding box 108 for the subject.

In some implementations, the system 100 can identify one or more objects in a scene based on the ground-truth object information. The system 100 can identify one or more subjects in a scene based on the ground-truth subject information. This can be advantageous for the system 100 to be able to receive a large amount of input data 104 (e.g., 3D data) regarding a 3D scene and determine valuable information (e.g., the locations of each object and/or subject in a scene) that can be useful for constructing a 3D scene graph.

In some implementations, the system 100 can perform input data processing which can include processing the input data 104, such as where the input data 104 is in a raw form, before providing the processed input data to the captioner 128. For example, the input data processing may include generating cropped images around each object and/or subject of the scene. For example, the system 100 can generate one or more cropped images from the one or more views regarding each object and/or subject present in the scene to be inputted to the captioner 128, based at least on the 2D bounding boxes 108. In another example, the input data processing may include resolving (e.g., removing) problematic (e.g., low resolution, duplicate, incorrectly labeled, noise containing, etc.) aspects of the scene (e.g., the one or more cropped images) to ensure quality and accuracy of the scene data to be inputted to the captioner 128.

Referring further to FIG. 1, the system 100 can include at least one captioner 128. The captioner 128 can include and/or cause a model 112 to generate one or more captions regarding the objects and/or subjects in the scene. The captioner 128 can provide the one or more captions based on the input data 104 using a model 112 and/or large language model (LLM) (or neural network models, multimodal language models, vision language models, small language models, diffusion models, etc.). The captions can provide a detailed description of the objects and/or subjects in the scene (e.g., including key elements, features). For example, the model 112 can generate one or more captions regarding each subject of a scene (e.g., subject captions) based on the actions 114, the class labels 106, and/or the 2D bounding boxes 108. The system 100 can cause the model 112 to generate one or more captions regarding each object of a scene (e.g., object captions) based on the class labels 106 and/or the 2D bounding boxes 108.

The system 100 can generate an object caption regarding an object in the scene for each view of the one or more views. For example, the captioner 128 can generate an object caption for a first view of an object based at least on an image (e.g., a cropped image) of the object in the first view and a prompt (e.g., “Describe the {class label} in the image in detail”). The captioner 128 can then generate an object caption of the object regarding each view provided to the captioner 128. Similarly, the system 100 can generate a subject caption regarding a subject in the scene for each view of the one or more views.

The system 100 can cause the model 112 to combine (e.g., fuse) captions regarding objects and/or subjects in the scene. The model 112 can receive one or more captions corresponding to each view for each object and/or subject in the scene. The model 112 can be instructed to analyze the one or more captions and generate a single caption (e.g., a fused caption) that summarizes the one or more captions. The single caption provides a holistic description of the object and/or subject based on the one or more views of the object and/or subject. For example, the system 100 can cause the model 112 to combine (e.g., fuse) the one or more subject captions regarding a subject to construct a fused subject caption. The fused subject caption can be a holistic description of the action performed by the subject and/or a summary of the one or more subject captions. The fused subject caption can be based at least on the actions 114 and the one or more object captions corresponding to the one or more views. The model 112 can combine (e.g., fuse) the one or more object captions regarding an object to construct a fused object caption. The fused object caption can be a holistic description of object and/or a summary of the one or more object captions. The fused object caption can be based at least on the one or more object captions corresponding to the one or more views.

Referring further to FIG. 1, the system 100 can include at least one three-dimensional (3D) graph generator 116. The 3D graph generator 116 can include and/or cause a model 120 (e.g., second model 120) to generate a 3D scene graph of the scene. The system 100 can provide a 3D scene graph of the scene using a model 120 and/or large language model (LLM) (or neural network models, multimodal language models, vision language models, small language models, diffusion models, etc.). The system can generate one or more nodes 118 and/or one or more edges 122 regarding the 3D scene using a model 120. The 3D graph generator 116 can use the one or more nodes 118 and/or the one or more edges 122 to generate a 3D scene graph.

In some implementations, the 3D graph generator 116 can construct one or more nodes 118 based on the ground-truth information. The one or more nodes 118 can represent each object and/or subject in the scene. Each node 118 can include an object and its corresponding fused object caption (or a subject and its corresponding fused subject caption).

The 3D graph generator 116 can generate one or more edges 122 that connect the one or more nodes 118. The one or more edges 122 can represent spatial relationships between one object/subject with another object/subject in the scene. For example, the system may generate one or more spatial edges, based at least on 3D bounding boxes 110. The 3D graph generator 116 can generate an edge between each object/subject in a scene with each other object/subject in the scene systematically (e.g., generate an edge between a first object and a second object, an edge between a first object and a third object, an edge between a first object and a first subject, etc.).

In some implementations, the system 100 can generate spatial edges among objects based at least on how objects are arranged relative to a ground. For example, the 3D graph generator 116 may build (e.g., generate, establish) a node hierarchy to connect nodes based at least on the 3D bounding boxes 110. The node hierarchy is determined by “supported by” relationships based at least on the 3D bounding boxes 110. For example, a scene may include a floor, objects on the floor, a table, and objects on the table. In such an example, the floor forms (e.g., is labelled as) the 0^{th} level of the node hierarchy, objects supported by the floor form the 1^{st} level of the node hierarchy, and objects supported by a table form the 2^{nd} level of the node hierarchy. While forming the node hierarchy, the 3D graph generator 116 connects the nodes with spatial edges as determined by the “supported by” relationships. Further, the 3D graph generator 116 can determine one or more spatial edges of the scene based at least on the 3D bounding boxes 110 by traversing (e.g., examining) all the objects at the same hierarchical level. For example, the 3D graph generator 116 can select a first node in a hierarchy and select a second node in the same hierarchy and compare the 3D bounding box coordinates 110 of the first node and the second node to generate a first spatial edge representing the spatial relationship between the first node and the second node. The 3D graph generator 116 may compare the 3D bounding box coordinates 110 for each pair of nodes in the scene to generate (e.g., add) one or more spatial edges for the 3D scene graph. Spatial edges may include, but are not limited to, “left”, “right”, “front”, “behind”, “far”, and “near” relationships. Relative spatial edges, such as “far” and “near”, can be determined by a predetermined threshold. For example, a “far from” edge may be generated between a first node and a second node if the first node is at least a predetermined amount of distance from the second node in the scene.

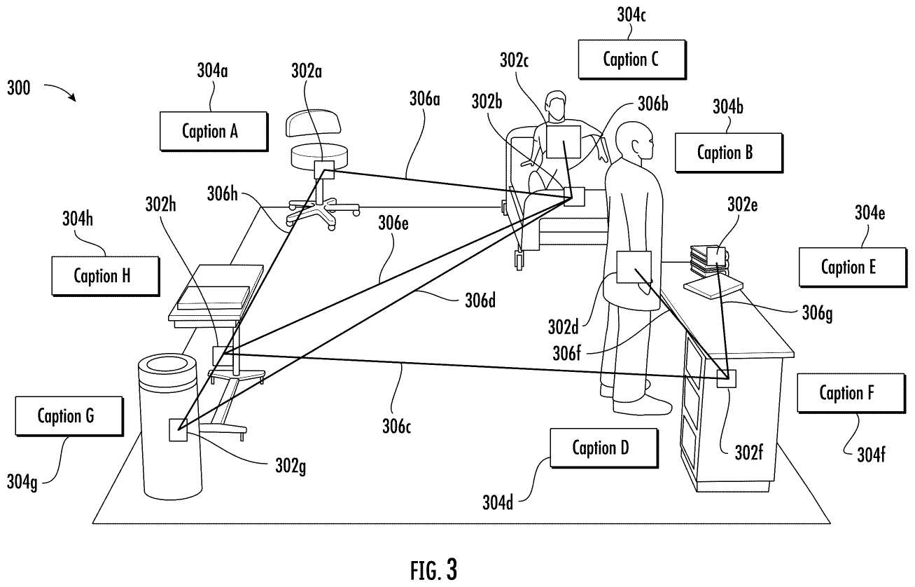

In some implementations, the system 100 can generate view-agnostic spatial relationships (e.g., spatial relationships not dependent on a view or angle of the scene) based at least on the one or more views of a scene. Providing one or more views of a scene can be advantageous to provide a 3D representation of the entire scene at once (e.g., viewing the entire scene through multiple viewpoints) which allows the system 100 to provide view-agnostic spatial relationships. For example, regarding FIG. 3, when standing by the desk in the front, right corner of the room, the chair is to the left of the desk. However, when standing on the opposite side of the room, facing the desk, the chair is to the right of the desk. An example of a view-agnostic spatial relationship regarding the 3D scene graph depicted in FIG. 3 is “the side table is in between the chair and the trash can”.

The 3D graph generator 116 can generate interaction edges (e.g., relationships) that connect the one or more nodes 118 (e.g., representing subjects in the scene). The interaction edges represent interaction relationships between each subject with every other subject in the scene and/or each subject with each object in the scene. For example, the 3D graph generator 116 can generate one or more interaction edges, using a model 120, based at least on the actions (e.g., description of an action being performed by a subject) 114 and the class labels 106. Since the 3D graph generator 116 can generate interaction edges, the system 100 can receive 3D scenes containing dynamic environments with humans (and/or animals) present and generate 3D scene graphs based on the dynamic scenes.

The system 100 can include at least one annotation generator 124. The system 100 can cause a model 126 (e.g., third model 126) to generate annotations for the 3D scene graph. For example, the system can generate task planning and supervised-finetuning question-answering annotations for the 3D scene graph, using a model 126. In some implementations, the annotation generator 124 can prompt the model 126 with one or more instructions to generate annotations based at least on the 3D scene graph and the scene data. In an example, a 3D scene graph may include a worker (e.g., a subject) with a generated fused caption of “3D model of a worker wearing a blue shirt and gray pants, viewed from four angles.” The processing circuits may provide a query (e.g., question) to the annotation generator 124 regarding the 3D scene graph. Examples of annotations may include queries such as “Can you tell me that is the farthest object from the object described as: \“3D model of a worker wearing a blue shirt and gray pants, viewed from four angles. \”? Respond with a sentence describing the farthest object” and “Could you tell me the number of cones in the scene? Make your response with only one number”, with corresponding answers being “A long, rectangular prism with an orange side and a purple top, featuring a smooth, metallic texture” and “2”.

In some implementations, the annotation generator 124 can generate and/or create a training dataset to update (e.g., train, fine-tune, perform transfer learning on) a model for 3D understanding. For example, the annotation generator 124 may pair outputs of model 126 (e.g., generated queries with corresponding generated responses, question-answer pairs, task planning prompts and outputs) for training and/or model updating purposes. The annotation generator 124 can use the scene data (e.g., nodes, edges) to generate annotations for a 3D scene and create paired data (e.g., to store in a training dataset) for training, updating, implementing, configuring, and/or using one or more machine learning models (e.g., a vision language model (VLM)) to understand 3D data (e.g., locations of objects and/or subjects in a 3D plane).

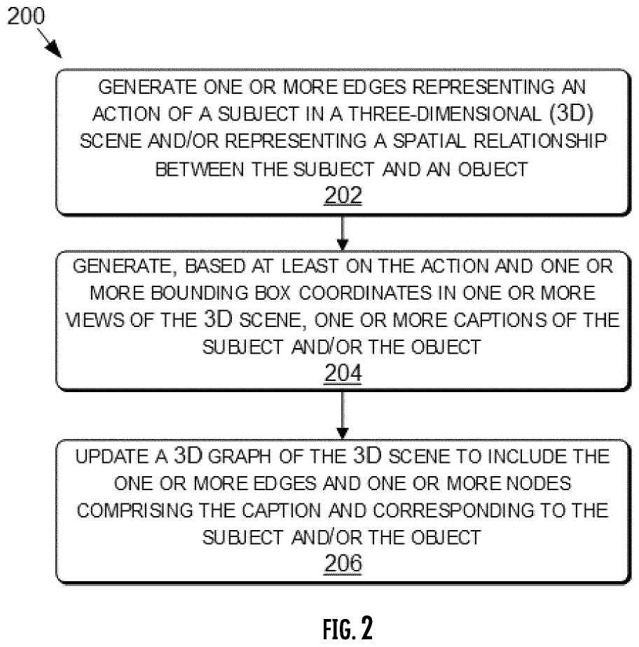

Now referring to FIG. 2, each block of method 200, described herein, comprises a computing process that may be performed using any combination of hardware, firmware, and/or software. For instance, various functions may be carried out using one or more processors executing instructions stored in one or more memories. The method may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method may additionally or alternatively be executed by any one system, or any combination of systems, including, but not limited to, those described herein.

FIG. 2 is a flow diagram showing a method 200 for generating and/or updating a 3D graph to include one or more nodes and/or one or more edges to represent objects in a 3D scene, in accordance with some implementations of the present disclosure. The method 200 can be performed responsive to instructions to generate graph information for configuring a machine learning model to annotate scenes. The method 200 can be performed responsive to one or more instances of data generation by a simulation, e.g., for one or more time steps of the simulation. The method 200 can be performed in a batch operation responsive to generation and/or reception of data relating to a plurality of time steps of the simulation.

The method 200, at block 202, includes generating one or more edges representing at least one of an action of a subject in a three-dimensional (3D) scene or a spatial relationship between the subject and an object in the 3D scene. For example, the edge representing the action can include a description of the action; the edge representing the spatial relationship can indicate at least one of a relative or an absolute position of the subject relative to the object and/or a frame of reference for the scene.

A determination can be made that the subject and object are present in the 3D scene, based at least on ground-truth information. The ground-truth information can include class labels, 2D bounding boxes, and/or 3D bounding boxes, such as from the 3D scene data, e.g., simulation data. The objects and/or subjects can be represented as nodes, which can be connected via spatial edges. In order to generate the spatial edges, a node hierarchy can be generated. The node hierarchy can assign each object and/or subject of the 3D scene into a hierarchy level. The hierarchy levels can be based at least on the spatial relationships between nodes as indicated by the 3D bounding boxes 110. For example, the floor will make up the 0^{th} level of the node hierarchy, objects supported by the floor make up the 1^{st} level, etc. Then, if the subject and the object are in the same hierarchy, the 3D bounding box coordinates of the subject and the object can be compared to generate one or more spatial edges (e.g., relationships) between the subject and the object. For example, the processing circuits can determine that the subject is near, far, left, right, front, behind, etc. relative to the object.

For the subject (and other humans and/or animals present in the scene), interaction edges can be generated. The interaction edges can be based at least on information retrieved from the simulation and/or the 3D scene regarding the subject, such as a sentence describing the action of the subject, and can include the class of the subject. An interaction edge between a first subject and a second subject represents the interaction relationship between the first subject and the second subject.

The method 200, at block 204, includes generating, based at least on the action and one or more bounding box coordinates in one or more views of the 3D scene, one or more captions of the subject and/or the object. The caption (e.g., one or more words or phrases) can be generated using a model (e.g., VLM, LLM, etc.), to provide a high-level description of the subject and the object. The caption can include key elements and/or features of the object. One or more captions can be generated using the model and based at least on one or more images (e.g., cropped images) surrounding the subject and/or object. The one or more images can correspond to one or more views of the subject and/or object. The one or more captions can be combined, such as to generate a summarized caption (e.g., a fused caption) regarding the subject and/or the object. The fused caption regarding the object (e.g., a fused object caption) can be based at least on 2D bounding box coordinates for each view of the object and the class label regarding the object. The fused caption regarding the subject (e.g., a fused subject caption) can be based at least on 2D bounding box coordinates for each view of the subject, the class label regarding the subject, and an action label (e.g., description of the action the subject is performing). Generating a fused caption regarding the subject and/or the object based at least on one or more captions corresponding to one or more views of the scene provides more accurate, comprehensive data regarding the subject and/or the object which can be used to construct the 3D scene graph.

The method 200, at block 206, includes updating a 3D scene graph of the 3D scene to include the one or more edges and the one or more nodes that include the caption and correspond to the subject and/or the object. The method 200 can include adding the one or more spatial edges between the subject and the object and the one or more interaction edges to the 3D scene graph. For example, the one or more nodes (e.g., representing the subject and/or the object) including the fused captions can be added to the 3D scene graph.

Referring now to FIG. 3, an example output of the 3D scene graph pipeline including a plurality of nodes and edges, in accordance with some implementations of the present disclosure. The 3D scene graph 300 includes nodes 302 (e.g., nodes 302a-302h). The nodes 302 represent each object and subject in the scene and include the corresponding object/subject caption 304 (e.g., captions 304a-304h). The 3D scene graph 300 also include edges 306 connecting each node to every other node of the scene.

In some implementations, the system 100 can receive ground-truth information regarding a scene to construct a 3D scene graph 300. The ground-truth information can include bounding box coordinates and class labels for each object and subject in the scene, and an action for each subject in the scene. The system 100 can identify each object and/or subject in the scene based at least on the ground-truth information. The system 100 can generate a node 302 regarding each object and/or subject in the scene based at least on the ground-truth information. In the scene, node 302a represents the chair, node 302b represents the hospital bed, node 302c represents the patient, node 302d represents the doctor, node 302e represents the bookset, node 302f represents the hospital desk, node 302g represents the trash can, and node 302h represents the side table.

The system 100 can generate one or more captions 304 for each object and/or subject in the scene. The captions 304 are fused captions, providing a highly accurate description of the object and/or subject. The captions 304 have been generated from one or more captions from one or more views of the object and/or subject. The one or more captions from the one or more views are summarized into fused captions 304 using a model. The nodes 302 can include the object and/or subject and the caption 304 describing said object and/or subject. Caption A provides a description of the chair: “A blue hospital chair with a round, circular seat, and a high backrest, possibly having a black color, is mounted on a five-pointed, silver-colored base with black casters.” Caption B provides a description of the hospital bed: “A hospital bed with a blue mattress, white plastic frame featuring circular cutouts, and four wheels at the base, is positioned on a yellow surface.” Caption C provides a description of the patient: “A patient is lying on a blue hospital bed, wearing a white top and pink pants, with their legs raised and bent at the knees, and has a blue pillow under their head, resting their arms by their sides, appearing to be in a relaxed position to take a break.” Caption D provides a description of the doctor: “A bald doctor with a neutral expression stands beside a desk, wearing a white lab coat, white pants, and white shoes, with a stethoscope hanging around his neck, and reviews a book in his right hand, likely the drug guide for the patient's treatment.” Caption E provides a description of the bookset: “A bookset with multiple colors including a green cover with a white spine, blue covers with white text, a yellow one, an orange one, and a white cover with a red spine, all stacked together in a vertical position.” Caption F provides a description of the hospital desk: “A modern hospital desk with a sleek, dark countertop, likely black, and a grey cabinet, featuring a metallic frame and at least on shelf and a drawer, standing upright on a beige or yellow floor with various items on top, such as books and a red stethoscope.” Caption G provides a description of the trash can: “A cylindrical trash can with a textured, two-tone blue surface—the top being darker than the base—and a black band around its middle, stands upright.”

The system 100 can generate one or more edges 306 between each node 302 in the scene based at least on the ground truth information. For example, the system 100 may generate an edge (e.g., spatial relationship) 306 connecting node 302a and node 302b (e.g., node 302a is to the left of node 302b, node 302a is far from node 302b). The system 100 can connect each node 302 with every other node to generate a plurality of edges 306 (e.g., connecting node 302a and 302c, connecting node 302b and 302c, etc.). The system 100 can provide one or more edges 306 to connect a first node with a second node. For example, a plurality of edges 306 may be generated to connect node 302b (corresponding to the hospital bed) to the node 302g (corresponding to the trash can) based at least on one or more spatial relationships between node 302a and node 302b. As shown in FIG. 3, edge 306a is provided between node 302a and node 302b, such that node 302a is “to the left of” and “far from” node 302b. Edge 306b is provided between node 302c and node 302b, such that node 302c is “laying on” node 302b. Edge 306c is provided between node 302h and node 302f, such that node 302h is “to the left of” and “far from” node 302f. Edge 306d is provided between node 302b and node 302g, such that node 302b is “to the right of”, “behind”, and “far from” node 302g. Edge 306e is provided between node 302b and node 302h, such that node 302b is “to the right of”, “behind”, and “far from” node 302h. Edge 306f is provided between node 302d and node 302f, such that node 302d is “standing beside” node 302f. Edge 306g is provided between node 302e and node 302f, such that node 302e is “supported by” node 302f. Edge 306h is provided between node 302a and node 302h, such that node 302a is “behind” and “far from” node 302h.

In some implementations, the system 100 can provide relative spatial edges (e.g., relationships based on how a first node is positioned in relation to a second node within a scene) based on a predetermined threshold. For example, edge 306a provides that node 302a is “far from” node 302b. This is based at least on the system 100 determining that node 302a is at least a threshold amount of distance away from node 302b.

In some implementations, the system 100 can label each object and subject as a region based at least on the bounding box coordinates. For example, the system 100 can label the blue chair as region 1 corresponding to node 302a, the bed as region 2 corresponding to node 302b, the patient as region 3 corresponding to node 302c, etc. The regions can assist the system 100 when generating one or more edges 306 for the scene graph.

In some implementations, the system 100 can directly input the 3D scene graph 300 to a language model (e.g., model 126) for downstream applications. The system 100 can input the 3D scene graph 300 to the annotation generator 124 to generate instruction-following annotations, using model 126. The system 100 can generate a plurality of question-answer annotation pairs, based at least on the 3D scene graph 300 according to instructions (e.g., “Create 3D question-answer pairs regarding this scene”). The instructions can be more or less detailed according to user preference and can specify a desired tone, length, style, complexity, etc. of the annotations. Example questions regarding the 3D scene graph 300 include “what is in the far left corner of the room?”, “is there a book sitting on top of the chair?”, “what is the height of the table?”, “what is the largest object in the room?” with corresponding answers being “a trash can”, “no”, “2.5 feet”, “the desk”.

In some implementations, the system 100 can generate a plurality of task planning annotations based at least on the 3D scene graph 300 according to instructions. For example, a task planning query may be inputted to a model 126, “pick a book from the books on the desk and place it on the chair”. The annotation generator 124 can plan (e.g., as if a robot is performing the task) to achieve the task as provided by the task planning query. The corresponding response may be outputted, “go to the hospital desk, inspect the books, pick up a book, walk to the chair, place book on the chair”.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed implementations may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more small language models (SLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

### Example Language Models

In at least some implementations, language models, such as models 112, models 120, and models 126 (with reference to FIG. 1), large language models (LLMs), small language models (SLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in implementations, based on the models being trained on massive datasets and having architectures with large number of learnable network parameters (weights and biases)—such as millions or billions of parameters. The LLMs/SLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure may be used exclusively for text processing, in implementations, whereas in other implementations, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures may be implemented in various implementations. For example, different architectures may be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) may be used, while in other implementations transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/SLMs/VLMs/MMLMs/etc. may also include one or more diffusion block(s) (e.g., denoisers). The LLMs/SLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/SLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular implementation and the task(s) being performed using the LLMs/SLMs/VLMs/MMLMs/etc.

In various implementations, the LLMs/SLMs/VLMs/MMLMs/etc. may be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models may not require task-specific or domain-specific training. LLMs/SLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/SLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure may be implemented using various model alignment techniques. For example, in some implementations, guardrails may be implemented to identify improper or undesired inputs (e.g., prompts) and/or outputs of the models. In doing so, the system may use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some implementations, the LLMs/SLMs/VLMs/MMLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data may be provided with the same input query and prompt (e.g., set of constraints, conditioners, etc.). In one or more implementations, the language models may be different versions of the same foundation model. In one or more implementations, at least one language model may be instantiated as multiple agents—e.g., more than one prompt may be provided to constrain, direct, or otherwise influence a style, a content, or a character, etc., of the output provided. In one or more example, non-limiting implementations, the same language model may be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more implementations, the output from one language model—or version, instance, or agent—maybe be provided as input to another language model for further processing and/or validation. In one or more implementations, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more implementations, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 4A is a block diagram of an example generative language model system 400 suitable for use in implementing at least some implementations of the present disclosure with reference to the 3D scene graph generation pipeline of FIG. 1. In the example illustrated in FIG. 4A, the generative language model system 400 includes a retrieval augmented generation (RAG) component 492, an input processor 405, a tokenizer 410, an embedding component 420, plug-ins/APIs 495, and a generative language model (LM) 430 (which may include an LLM, a SLM, a VLM, a multi-modal LM, etc.).

At a high level, the input processor 405 may receive an input 401 comprising text and/or other types of input data (e.g., audio data, video data, image data, sensor data (e.g., LiDAR, RADAR, ultrasonic, etc.), 3D design data, CAD data, universal scene descriptor (USD) data such as OpenUSD, etc.), depending on the architecture of the generative LM 430 (e.g., LLM/SLM/VLM/MMLM/etc.). In some implementations, the input 401 includes plain text in the form of one or more sentences, paragraphs, and/or documents. Additionally or alternatively, the input 401 may include numerical sequences, precomputed embeddings (e.g., word or sentence embeddings), and/or structured data (e.g., in tabular formats, JSON, or XML). In some implementations in which the generative LM 430 is capable of processing multi-modal inputs, the input 401 may combine text (or may omit text) with image data, audio data, video data, design data, USD data, and/or other types of input data, such as but not limited to those described herein. Taking raw input text as an example, the input processor 405 may prepare raw input text in various ways. For example, the input processor 405 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 405 may remove stopwords to reduce noise and focus the generative LM 430 on more meaningful content. The input processor 405 may apply text normalization, for example, by converting all characters to lowercase, removing accents, and/or or handling special cases like contractions or abbreviations to ensure consistency. These are just a few examples, and other types of input processing may be applied.

In some implementations, a RAG component 492 (which may include one or more RAG models, and/or may be performed using the generative LM 430 itself) may be used to retrieve additional information to be used as part of the input 401 or prompt. RAG may be used to enhance the input to the LLM/SLM/VLM/MMLM/etc. with external knowledge, so that answers to specific questions or queries or requests are more relevant—such as in a case where specific knowledge is required. The RAG component 492 may fetch this additional information (e.g., grounding information, such as grounding text/image/video/audio/USD/CAD/etc.) from one or more external sources, which can then be fed to the LLM/SLM/VLM/MMLM/etc. along with the prompt to improve accuracy of the responses or outputs of the model.

For example, in some implementations, the input 401 may be generated using the query or input to the model (e.g., a question, a request, etc.) in addition to data retrieved using the RAG component 492. In some implementations, the input processor 405 may analyze the input 401 and communicate with the RAG component 492 (or the RAG component 492 may be part of the input processor 405, in implementations) in order to identify relevant text and/or other data to provide to the generative LM 430 as additional context or sources of information from which to identify the response, answer, or output 490, generally. For example, where the input indicates that the user is interested in a desired tire pressure for a particular make and model of vehicle, the RAG component 492 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 492 may retrieve a prior stored conversation history—or at least a summary thereof—and include the prior conversation history along with the current ask/request as part of the input 401 to the generative LM 430.

The RAG component 492 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 492 and the embeddings of the chunks along with the embeddings of the query may be compared to identify the most similar/related embeddings to the query, which may be supplied to the generative LM 430 to generate an output.

In some implementations, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/SLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/SLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/SLM/VLM/MMLM/etc. to answer using them. The knowledge graph, in such implementations, may contain relevant textual content and metadata about the knowledge graph as well as be integrated with a vector database. In some implementations, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/SLM/VLM/MMLM/etc. may summarize the results. In such an example, the graph may store relevant factual information, and a query (natural language query) to graph query tool (NL-to-Graph-query tool) and entity linking may be used. In some implementations, graph RAG (e.g., using a graph database) may be combined with standard (e.g., vector database) RAG, and/or other RAG types, to benefit from multiple approaches.

In any implementations, the RAG component 492 may implement a plugin, API, user interface, and/or other functionality to perform RAG. For example, a graph RAG plug-in may be used by the LLM/SLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 410 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 430 to understand morphological variations and handle out-of-vocabulary words more effectively. Character-based tokenization represents each character as a separate token, enabling the generative LM 430 to process text at a fine-grained level. The choice of tokenization strategy may depend on factors such as the language being processed, the task at hand, and/or characteristics of the training dataset. As such, the tokenizer 410 may convert the (e.g., processed) text into a structured format according to tokenization schema being implemented in the particular implementation.

The embedding component 420 may use any known embedding technique to transform discrete tokens into (e.g., dense, continuous vector) representations of semantic meaning. For example, the embedding component 420 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 401 includes image data/video data/etc., the input processor 401 may resize the data to a standard size compatible with format of a corresponding input channel and/or may normalize pixel values to a common range (e.g., 0 to 1) to ensure a consistent representation, and the embedding component 420 may encode the image data using any known technique (e.g., using one or more convolutional neural networks (CNNs) to extract visual features). In some implementations in which the input 401 includes audio data, the input processor 401 may resample an audio file to a consistent sampling rate for uniform processing, and the embedding component 420 may use any known technique to extract and encode audio features—such as in the form of a spectrogram (e.g., a mel-spectrogram). In some implementations in which the input 401 includes video data, the input processor 401 may extract frames or apply resizing to extracted frames, and the embedding component 420 may extract features such as optical flow embeddings or video embeddings and/or may encode temporal information or sequences of frames. In some implementations in which the input 401 includes multi-modal data, the embedding component 420 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 430 and/or other components of the generative LM system 400 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 420 may apply an encoded representation of the input 401 to the generative LM 430, and the generative LM 430 may process the encoded representation of the input 401 to generate an output 490, which may include responsive text and/or other types of data.

As described herein, in some implementations, the generative LM 430 may be configured to access or use—or capable of accessing or using—plug-ins/APIs 495 (which may include one or more plug-ins, application programming interfaces (APIs), databases, data stores, repositories, etc.). For example, for certain tasks or operations that the generative LM 430 is not ideally suited for, the model may have instructions (e.g., as a result of training, and/or based on instructions in a given prompt, such as those retrieved using the RAG component 492) to access one or more plug-ins/APIs 495 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 495 to the plug-in/API 495, the plug-in/API 495 may process the information and return an answer to the generative LM 430, and the generative LM 430 may use the response to generate the output 490. This process may be repeated—e.g., recursively—for any number of iterations and using any number of plug-ins/APIs 495 until an output 490 that addresses each ask/question/request/process/operation/etc. from the input 401 can be generated. As such, the model(s) may not only rely on its own knowledge from training on a large dataset(s) and/or from data retrieved using the RAG component 492, but also on the expertise or optimized nature of one or more external resources—such as the plug-ins/APIs 495.

FIG. 4B is a block diagram of an example implementation in which the generative LM 430 includes a transformer encoder-decoder. For example, assume input text such as “Who discovered gravity” is tokenized (e.g., by the tokenizer 410 of FIG. 4A) into tokens such as words, and each token is encoded (e.g., by the embedding component 420 of FIG. 94A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 435 of the generative LM 430.

In an example implementation, the encoder(s) 435 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 440 may convert the context vector into attention vectors (keys and values) for the decoder(s) 445.

In an example implementation, the decoder(s) 445 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 435, in an example transformer architecture, each token (e.g., word) flows through a separate path in the decoder(s) 445. During a first pass, the decoder(s) 445, a classifier 450, and a generation mechanism 455 may generate a first token, and the generation mechanism 455 may apply the generated token as an input during a second pass. The process may repeat in a loop, successively generating and adding tokens (e.g., words) to the output from the preceding pass and applying the token embeddings of the composite sequence with positional encodings as an input to the decoder(s) 445 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 435, except that it creates its queries from the layer below it and takes the keys and values (e.g., matrix) from the output of the encoder(s) 435.

As such, the decoder(s) 445 may output some decoded (e.g., vector) representation of the input being applied during a particular pass. The classifier 450 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 455 may select or sample a word or token based on a corresponding predicted probability (e.g., select the word with the highest predicted probability) and append it to the output from a previous pass, generating each word or token sequentially. The generation mechanism 455 may repeat the process, triggering successive decoder inputs and corresponding predictions until selecting or sampling a symbol or token that represents the end of the response, at which point, the generation mechanism 455 may output the generated response.

FIG. 4C is a block diagram of an example implementation in which the generative LM 430 includes a decoder-only transformer architecture. For example, the decoder(s) 460 of FIG. 4C may operate similarly as the decoder(s) 445 of FIG. 4B except each of the decoder(s) 460 of FIG. 4C omits the encoder-decoder self-attention layer (since there is no encoder in this implementation). As such, the decoder(s) 460 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 460. As with the decoder(s) 445 of FIG. 4B, each token (e.g., word) may flow through a separate path in the decoder(s) 460, and the decoder(s) 460, a classifier 465, and a generation mechanism 470 may use auto-regression to sequentially generate one token at a time until predicting a symbol or token that represents the end of the response. The classifier 465 and the generation mechanism 470 may operate similarly as the classifier 450 and the generation mechanism 455 of FIG. 4B, with the generation mechanism 470 selecting or sampling each successive output token based on a corresponding predicted probability and appending it to the output from a previous pass, generating each token sequentially until selecting or sampling a symbol or token that represents the end of the response. These architectures can be implemented within the system 100 as described with reference to FIG. 1 and the 3D scene graph generation pipeline. These and other architectures described herein are meant simply as examples, and other suitable architectures may be implemented within the scope of the present disclosure.

### Example Computing Device

FIG. 5 is a block diagram of an example computing device(s) 500 suitable for use in implementing some implementations of the present disclosure with reference to the 3D scene graph generation pipeline of FIG. 1. Computing device 500 may include an interconnect system 502 that directly or indirectly couples the following devices: memory 504, one or more central processing units (CPUs) 506, one or more graphics processing units (GPUs) 508, a communication interface 510, input/output (I/O) ports 512, input/output components 514, a power supply 516, one or more presentation components 518 (e.g., display(s)), and one or more logic units 520. In at least one implementation, the computing device(s) 500 may comprise one or more virtual machines (VMs), and/or any of the components thereof may comprise virtual components (e.g., virtual hardware components). For non-limiting examples, one or more of the GPUs 508 may comprise one or more vGPUs, one or more of the CPUs 506 may comprise one or more vCPUs, and/or one or more of the logic units 520 may comprise one or more virtual logic units. As such, a computing device(s) 500 may include discrete components (e.g., a full GPU dedicated to the computing device 500), virtual components (e.g., a portion of a GPU dedicated to the computing device 500), or a combination thereof.

Although the various blocks of FIG. 5 are shown as connected via the interconnect system 502 with lines, this is not intended to be limiting and is for clarity only. For example, in some implementations, a presentation component 518, such as a display device, may be considered an I/O component 514 (e.g., if the display is a touch screen). As another example, the CPUs 506 and/or GPUs 508 may include memory (e.g., the memory 504 may be representative of a storage device in addition to the memory of the GPUs 508, the CPUs 506, and/or other components). As such, the computing device of FIG. 5 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5.

The interconnect system 502 may represent one or more links or busses, such as an address bus, a data bus, a control bus, or a combination thereof. The interconnect system 502 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 506 may be directly connected to the memory 504. Further, the CPU 506 may be directly connected to the GPU 508. Where there is direct, or point-to-point connection between components, the interconnect system 502 may include a PCIe link to carry out the connection. In these examples, a PCI bus need not be included in the computing device 500.

The memory 504 may include any of a variety of computer-readable media. The computer-readable media may be any available media that may be accessed by the computing device 500. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 504 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 500. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 506 may be configured to execute at least some of the computer-readable instructions to control one or more components of the computing device 500 to perform one or more of the methods and/or processes described herein. The CPU(s) 506 may each include one or more cores (e.g., one, two, four, eight, twenty-eight, seventy-two, etc.) that are capable of handling a multitude of software threads simultaneously. The CPU(s) 506 may include any type of processor, and may include different types of processors depending on the type of computing device 500 implemented (e.g., processors with fewer cores for mobile devices and processors with more cores for servers). For example, depending on the type of computing device 500, the processor may be an Advanced RISC Machines (ARM) processor implemented using Reduced Instruction Set Computing (RISC) or an x86 processor implemented using Complex Instruction Set Computing (CISC). The computing device 500 may include one or more CPUs 506 in addition to one or more microprocessors or supplementary co-processors, such as math co-processors.

In addition to or alternatively from the CPU(s) 506, the GPU(s) 508 may be configured to execute at least some of the computer-readable instructions to control one or more components of the computing device 500 to perform one or more of the methods and/or processes described herein. One or more of the GPU(s) 508 may be an integrated GPU (e.g., with one or more of the CPU(s) 506 and/or one or more of the GPU(s) 508 may be a discrete GPU. In implementations, one or more of the GPU(s) 508 may be a coprocessor of one or more of the CPU(s) 506. The GPU(s) 508 may be used by the computing device 500 to render graphics (e.g., 3D graphics) or perform general purpose computations. For example, the GPU(s) 508 may be used for General-Purpose computing on GPUs (GPGPU). The GPU(s) 508 may include hundreds or thousands of cores that are capable of handling hundreds or thousands of software threads simultaneously. The GPU(s) 508 may generate pixel data for output images in response to rendering commands (e.g., rendering commands from the CPU(s) 506 received via a host interface). The GPU(s) 508 may include graphics memory, such as display memory, for storing pixel data or any other suitable data, such as GPGPU data. The display memory may be included as part of the memory 504. The GPU(s) 508 may include two or more GPUs operating in parallel (e.g., via a link). The link may directly connect the GPUs (e.g., using NVLINK) or may connect the GPUs through a switch (e.g., using NVSwitch). When combined together, each GPU 508 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 506 and/or the GPU(s) 508, the logic unit(s) 520 may be configured to execute at least some of the computer-readable instructions to control one or more components of the computing device 500 to perform one or more of the methods and/or processes described herein. In implementations, the CPU(s) 506, the GPU(s) 508, and/or the logic unit(s) 520 may discretely or jointly perform any combination of the methods, processes and/or portions thereof. One or more of the logic units 520 may be part of and/or integrated in one or more of the CPU(s) 506 and/or the GPU(s) 508 and/or one or more of the logic units 520 may be discrete components or otherwise external to the CPU(s) 506 and/or the GPU(s) 508. In implementations, one or more of the logic units 520 may be a coprocessor of one or more of the CPU(s) 506 and/or one or more of the GPU(s) 508.

Examples of the logic unit(s) 520 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 510 may include one or more receivers, transmitters, and/or transceivers that allow the computing device 500 to communicate with other computing devices via an electronic communication network, included wired and/or wireless communications. The communication interface 510 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 520 and/or communication interface 510 may include one or more data processing units (DPUs) to transmit data received over a network and/or through interconnect system 502 directly to (e.g., a memory of) one or more GPU(s) 508.

The I/O ports 512 may allow the computing device 500 to be logically coupled to other devices including the I/O components 514, the presentation component(s) 518, and/or other components, some of which may be built in to (e.g., integrated in) the computing device 500. Illustrative I/O components 514 include a microphone, mouse, keyboard, joystick, game pad, game controller, satellite dish, scanner, printer, wireless device, etc. The I/O components 514 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 500. The computing device 500 may be include depth cameras, such as stereoscopic camera systems, infrared camera systems, RGB camera systems, touchscreen technology, and combinations of these, for gesture detection and recognition. Additionally, the computing device 500 may include accelerometers or gyroscopes (e.g., as part of an inertia measurement unit (IMU)) that allow detection of motion. In some examples, the output of the accelerometers or gyroscopes may be used by the computing device 500 to render immersive augmented reality or virtual reality.

The power supply 516 may include a hard-wired power supply, a battery power supply, or a combination thereof. The power supply 516 may provide power to the computing device 500 to allow the components of the computing device 500 to operate.

The presentation component(s) 518 may include a display (e.g., a monitor, a touch screen, a television screen, a heads-up-display (HUD), other display types, or a combination thereof), speakers, and/or other presentation components. The presentation component(s) 518 may receive data from other components (e.g., the GPU(s) 508, the CPU(s) 506, DPUs, etc.), and output the data (e.g., as an image, video, sound, etc.).

### Example Data Center

FIG. 6 illustrates an example data center 600 that may be used in at least one implementations of the present disclosure, such as the 3D scene graph generation pipeline with reference to FIG. 1. The data center 600 may include a data center infrastructure layer 610, a framework layer 620, a software layer 630, and/or an application layer 640.

As shown in FIG. 6, the data center infrastructure layer 610 may include a resource orchestrator 612, grouped computing resources 614, and node computing resources (“node C.R.s”) 616(1)-616(N), where “N” represents any whole, positive integer. In at least one implementation, node C.R.s 616(1)-616(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 616(1)-616(N) may correspond to a server having one or more of the above-mentioned computing resources. In addition, in some implementations, the node C.R.s 616(1)-6161(N) may include one or more virtual components, such as vGPUs, vCPUs, and/or the like, and/or one or more of the node C.R.s 616(1)-616(N) may correspond to a virtual machine (VM).

In at least one implementation, grouped computing resources 614 may include separate groupings of node C.R.s 616 housed within one or more racks (not shown), or many racks housed in data centers at various geographical locations (also not shown). Separate groupings of node C.R.s 616 within grouped computing resources 614 may include grouped compute, network, memory or storage resources that may be configured or allocated to support one or more workloads. In at least one implementation, several node C.R.s 616 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 612 may configure or otherwise control one or more node C.R.s 616(1)-616(N) and/or grouped computing resources 614. In at least one implementation, resource orchestrator 612 may include a software design infrastructure (SDI) management entity for the data center 600. The resource orchestrator 612 may include hardware, software, or some combination thereof.

In at least one implementation, as shown in FIG. 6, framework layer 620 may include a job scheduler 628, a configuration manager 634, a resource manager 636, and/or a distributed file system 638. The framework layer 620 may include a framework to support software 632 of software layer 630 and/or one or more application(s) 642 of application layer 640. The software 632 or application(s) 642 may respectively include web-based service software or applications, such as those provided by Amazon Web Services, Google Cloud and Microsoft Azure. The framework layer 620 may be, but is not limited to, a type of free and open-source software web application framework such as Apache Spark™ (hereinafter “Spark”) that may use distributed file system 638 for large-scale data processing (e.g., “big data”). In at least one implementation, job scheduler 628 may include a Spark driver to facilitate scheduling of workloads supported by various layers of data center 600. The configuration manager 634 may be capable of configuring different layers such as software layer 630 and framework layer 620 including Spark and distributed file system 638 for supporting large-scale data processing. The resource manager 636 may be capable of managing clustered or grouped computing resources mapped to or allocated for support of distributed file system 638 and job scheduler 628. In at least one implementation, clustered or grouped computing resources may include grouped computing resource 614 at data center infrastructure layer 610. The resource manager 636 may coordinate with resource orchestrator 612 to manage these mapped or allocated computing resources.

In at least one implementation, software 632 included in software layer 630 may include software used by at least portions of node C.R.s 616(1)-616(N), grouped computing resources 614, and/or distributed file system 638 of framework layer 620. One or more types of software may include, but are not limited to, Internet web page search software, e-mail virus scan software, database software, and streaming video content software.

In at least one implementation, application(s) 642 included in application layer 640 may include one or more types of applications used by at least portions of node C.R.s 616(1)-616(N), grouped computing resources 614, and/or distributed file system 638 of framework layer 620. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 634, resource manager 636, and resource orchestrator 612 may implement any number and type of self-modifying actions based on any amount and type of data acquired in any technically feasible fashion. Self-modifying actions may relieve a data center operator of data center 600 from making possibly bad configuration decisions and possibly avoiding underutilized and/or poor performing portions of a data center.

The data center 600 may include tools, services, software or other resources to train one or more machine learning models or predict or infer information using one or more machine learning models according to one or more implementations described herein. For example, a machine learning model(s) may be trained by calculating weight parameters according to a neural network architecture using software and/or computing resources described above with respect to the data center 600. In at least one implementation, trained or deployed machine learning models corresponding to one or more neural networks may be used to infer or predict information using resources described above with respect to the data center 600 by using weight parameters calculated through one or more training techniques, such as but not limited to those described herein.

In at least one implementation, the data center 600 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing implementations of the disclosure may include one or more client devices, servers, network attached storage (NAS), other backend devices, and/or other device types. The client devices, servers, and/or other device types (e.g., each device) may be implemented on one or more instances of the computing device(s) 500 of FIG. 5—e.g., each device may include similar components, features, and/or functionality of the computing device(s) 500. In addition, where backend devices (e.g., servers, NAS, etc.) are implemented, the backend devices may be included as part of a data center 600, an example of which is described in more detail herein with respect to FIG. 6.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one implementation, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In implementations, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 500 described herein with respect to FIG. 5. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
generate a first edge representing an action of a subject in a three-dimensional (3D) scene with respect to an object in the 3D scene;
generate, based at least on the action and one or more bounding boxes of the subject in one or more views of the 3D scene, a caption representing the subject;
generate, based at least on 3D coordinates for the 3D scene, a second edge representing a spatial relationship between the subject and the object; and
update a 3D graph of the 3D scene to include a first node that corresponds to the subject and comprises the caption and a second node that corresponds to the object, the 3D graph mapping the first edge and the second edge between the first node and the second node.

2. The one or more processors of claim 1, wherein the processing circuitry is to retrieve, from a simulation of the 3D scene, the action, the one or more bounding boxes, the 3D coordinates, and a class label of at least one of the subject or the object.

3. The one or more processors of claim 1, wherein the processing circuitry is to generate the caption based at least on a class label of the subject.

4. The one or more processors of claim 1, wherein the processing circuitry is to generate the first edge, the caption, and the second edge using one or more language models.

5. The one or more processors of claim 1, wherein:
the object is a first object and the caption is a first caption; and
the processing circuitry is to generate, using a language model, a second caption of the first object, a third caption of a second object in the 3D scene, and a third edge between the second object and at least one of the subject or the first object, and to update the 3D graph to assign the second caption to the second node and the third caption to a third node representing the second object.

6. The one or more processors of claim 1, wherein:
a plurality of views of the scene comprise the one or more views, and a plurality of bounding boxes of the subject comprise the one or more bounding boxes; and
the processing circuitry is to generate, using a language model and for each view of the plurality of views, a view caption of the subject, and to generate the caption based at least on the view caption for each view of the plurality of views.

7. The one or more processors of claim 1, wherein the processing circuitry is to update a vision language model (VLM) according to the 3D graph.

8. The one or more processors of claim 1, wherein the processing circuitry is to determine the spatial relationship, based at least on the 3D coordinates, relative to a predetermined frame of reference of the scene.

9. The one or more processors of claim 1, wherein the one or more processors are comprised in at least one of:
a system implementing one or more multi-model language models;
a system implementing one or more large language models (LLMs);
a system implementing one or more small language models (SLMs);
a system implementing one or more vision language models (VLMs);
a system for generating synthetic data;
a system for generating synthetic data using AI;
a system for performing collaborative content creation for 3D assets;
a system for performing deep learning operations;
a control system for an autonomous or semi-autonomous machine;
a perception system for an autonomous or semi-autonomous machine;
a system for performing simulation operations;
a system for performing digital twin operations;
a system for performing light transport simulation;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system incorporating one or more virtual machines (VMs);
a system implemented at least partially in a data center; or
a system implemented at least partially using cloud computing resources.

10. A system comprising one or more processors to:
obtain, from a simulation environment, one or more views of a three-dimensional (3D) scene for generating a 3D graph of the 3D scene;
determine a first edge representing an action of a subject on an object in the 3D scene;
determine, based at least on the action and one or more bounding boxes of the subject in the one or more views of the 3D scene, a caption representing the subject;
determine, based at least on 3D coordinates for the 3D scene, a second edge representing a spatial relationship between the subject and the object; and
generate the 3D graph of the 3D scene using at least the first edge, the second edge, the caption, a first node corresponding to the subject, and a second node corresponding to the object.

11. The system of claim 10, wherein the one or more processors are to retrieve, from a simulation of the 3D scene, the action, the one or more bounding boxes, the 3D coordinates, and a class label of at least one of the subject or the object.

12. The system of claim 10, wherein the one or more processors are to generate the caption based at least on a class label of the subject.

13. The system of claim 10, wherein the one or more processors are to generate the first edge, the caption, and the second edge using one or more language models.

14. The system of claim 10, wherein:
the object is a first object and the caption is a first caption; and
the one or more processors are to generate, using a language model, a second caption of the first object, a third caption of a second object in the 3D scene, and a third edge between the second object and at least one of the subject or the first object, and to update the 3D graph to assign the second caption to the second node and the third caption to a third node representing the second object.

15. The system of claim 10, wherein:
a plurality of views of the scene comprise the one or more views, and a plurality of bounding boxes of the subject comprise the one or more bounding boxes; and
the one or more processors are to generate, using a language model and for each view of the plurality of views, a view caption of the subject, and to generate the caption based at least on the view caption for each view of the plurality of views.

16. The system of claim 10, wherein the one or more processors are to update a vision language model (VLM) according to the 3D graph.

17. The system of claim 10, wherein the one or more processors are to determine the spatial relationship, based at least on the 3D coordinates, relative to a predetermined frame of reference of the scene.

18. The system of claim 10, wherein the method is implemented in at least one of:
a system for generating synthetic data;
a system implementing one or more large language models (LLMs);
a system implementing one or more small language models (SLMs);
a system implementing one or more vision language models (VLMs);
a system for performing conversational AI operations;
a system implementing one or more multi-model language models;
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data using AI;
a system incorporating one or more virtual machines (VMs);
a system implemented at least partially in a data center; or
a system implemented at least partially using cloud computing resources.

19. A method, comprising:
obtaining, from a simulation environment, a dataset comprising at least a plurality of views associated with a three-dimensional (3D) scene; and
updating, based at least on the dataset, a 3D graph of the 3D scene by:
generating a first node representing a subject in the 3D scene and a second node representing an object in the 3D scene;
generating a first edge representing an action of the subject with respect to the object;
generating, based at least on the action and one or more bounding boxes of the subject in the plurality of views of the 3D scene, a caption representing the subject; and
generating, based at least on 3D coordinates for the 3D scene, a second edge representing a spatial relationship between the subject and the object.

20. The method of claim 19, wherein the method is implemented in at least one of:
a system for generating synthetic data;
a system implementing one or more large language models (LLMs);
a system implementing one or more small language models (SLMs);
a system implementing one or more vision language models (VLMs);
a system for performing conversational AI operations;
a system implementing one or more multi-model language models;
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for generating synthetic data using AI;
a system incorporating one or more virtual machines (VMs);
a system implemented at least partially in a data center; or
a system implemented at least partially using cloud computing resources.
